(19) United States
(12) Patent Application Publication
(10) Pub. No.: US 2011/0179212 A1
(43) Pub. Date: Jul. 21, 2011

(54) Bus arbitration for sideband signals

(76) Inventor: Charles Andrew Hartman, Ft Collins, CO (US)

(21) Appl. No.: 12/690,819

(22) Filed: Jan. 20, 2010

(51) Int. Cl. G06F 13/36

(52) U.S. Cl. 710/309

(57) ABSTRACT

Systems and methods of bus arbitration for sideband signals in a multichip system are disclosed. An exemplary method comprises packaging at least one sideband signal as a micropacket. The method also comprises holding the micropacket in an outgoing sideband register. The method also comprises monitoring a bus for a quiescent state, the bus having a plurality of links to other chips in the multichip system. The method also comprises issuing the micropacket from the outgoing sideband register if the bus is in a quiescent state.

### BACKGROUND

Multichip systems may include any number of processors, processing units, application specific integrated circuits (ASICs), field programmable gate arrays (FPGAs), or other circuitry generally referred to herein as “chips.” A bus links the chips to one another for communications using bus transactions. Firmware and/or circuitry in the chips loads and unloads the bus transactions on the bus.

In addition to conventional bus transactions, the chips may also utilize separate sideband signals for communications. Sideband signals may include status signals, strapping signals, reset signals, interrupt signals, fault signals, and handshake interlocks, to name only a few examples.

Sideband signals may be “wrapped” into a bus transaction and sent over the bus as conventional bus transactions utilizing the bus transfer protocol. However, this solution utilizes bus cycles to transfer the sideband signals as conventional bus transactions, taking away from the primary function of the bus (i.e., to transfer higher-level bus communications). In addition, this solution also requires a separate bus master at the issuing chip to package the sideband signals as conventional bus transactions and issue the packaged sideband signals over the bus. A separate bus master is also needed at the receiving chip to unpackage the sideband signals.

Sideband signals can generally tolerate some latency. Therefore, these sideband signals may instead be communicated between the chips via hardwired, dedicated lines instead of being provided onto the bus as conventional bus transactions. However, this solution requires discrete pins on each chip, and additional wiring on the circuit board, increasing cost and complexity.

### BRIEF DESCRIPTION OF THE DRAWINGS

FIG. 1 is a high level schematic diagram of an exemplary multichip system which may utilize bus arbitration for sideband signals.

FIGS. 2a-c are high level illustrations of exemplary data packets.

FIG. 3 is a detailed schematic diagram of an exemplary bus agent as it may be implemented in a multichip system for bus arbitration for sideband signals.

FIGS. 4a and 4b are timing diagrams illustrating exemplary bus arbitration for sideband signals.

FIG. 5 is a flowchart illustrating exemplary operations of bus arbitration for sideband signals.

### DETAILED DESCRIPTION

Briefly, systems and methods of bus arbitration for sideband signals may be implemented as a programmable hardware structure. Program code (e.g., firmware) monitors the bus for quiescent states, and issues the sideband signals as “micropackets” onto the bus during these quiescent states. Sideband signals may be “injected” onto the bus (e.g., using time division multiplexing (TDM) techniques) without interfering with conventional bus traffic. Accordingly, the embodiments described herein maintain overall performance of the multichip system, while reducing the number of (or altogether eliminating the need for) hardwired, dedicated lines for sideband signals.

In an exemplary embodiment, existing queues may be used to reduce the need for additional hardware. In addition, the size of the micropackets may be specified, and the size may be changed over time (e.g., based on performance statistics and changing speeds for different links), so as to maximize the number of sideband signals that can be issued over the bus without interfering with conventional bus traffic.

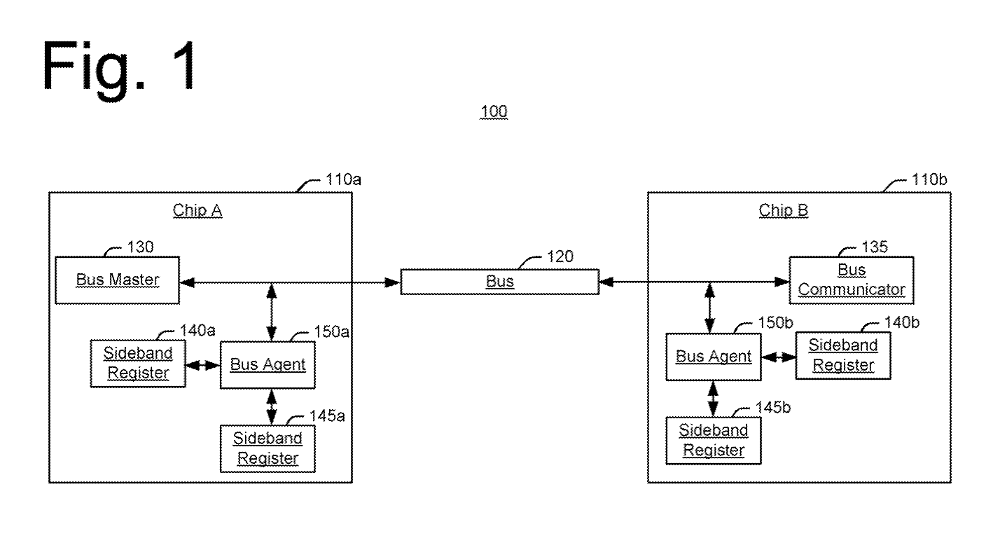

FIG. 1 is a high level schematic diagram of an exemplary multichip system 100. The multichip system 100 may be a circuit board including a plurality of processors, processing units, ASICs, FPGAs, and/or other chips generally referred to as chips 110a and 110b (labeled “Chip A” and “Chip B”), in addition to other circuitry such as, but not limited to, memory components (not shown). Of course, while only two chips are shown in FIG. 1 for purposes of illustration, any number of chips may be implemented according to the exemplary embodiments described herein.

A bus 120 may be provided to connect the chips 110a and 110b to each other and to other components. A bus master 130 may be provided in one of the chips 110a, 110b, and a bus communicator 135 may be provided in the other chip or chips for handling usual bus transactions on the bus 120.

Generally, a bus may include circuitry and program code (e.g., firmware) to connect various components to one or more other components on a circuit board (e.g., memory components). Any of the components may connect via the respective bus master 130. The bus master 130 provides basic bus arbitration for bus transactions. Although all of the components may be simultaneously connected to the bus 120, no two or more bus transactions may be issued over the bus at the same time. If it is requested to add two or more bus transactions to the bus 120 at the same time, arbitration by the bus master 130 determines which request has priority and allows that bus transaction to be issued on the bus 120.

It is noted that the bus 120 may connect any number of chips and/or other circuitry components in the multichip system 100. Although there are no theoretical limits on the number of components that can be included in a multichip system 100, the number of components are limited primarily by the connectivity being implemented. It is also noted that the multichip system 100 may include more than one bus 120.

The multichip system 100 may also include an outgoing sideband register 140a, 140b and an incoming sideband registers 145a, 145b for storing sideband signals on each of the chips 110a, 110b, respectively. The sideband registers may be implemented as firmware writable registers. In an exemplary embodiment, wait registers may be implemented in existing hardware, such as, e.g., the onboard queues. In addition, the registers may be encoded for each possible number of valid wideband signals in a maximum length micropacket that is expected to be issued and/or received over the bus 120. The registers may also be constructed so that the registers do not accept invalid micropackets.

The sideband registers 145a, 145b are managed by a bus agents 150a, 150b on each of the chips 110a, 110b, respectively. The bus agents 150a, 150b is operatively associated with the bus 120, to link the sideband registers 145a, 145b to other chips in the multichip system 100. The bus agents 150a, 150b may be encoded to monitor if the bus 120 is in a quiescent state. The bus agents 150a, 150b may also be encoded to issue the sideband signals from the outgoing sideband registers 140a, 140b if the bus 150 is in a quiescent state.

In an exemplary embodiment, the bus agents 150a, 150b may be configured to package one or more sideband signal as a micropacket for issuing over the bus 120. Likewise, the bus agents 150a, 150b may be configured to unpackage one or more sideband signal from the micropackets received over the bus 120 and issue the sideband signals to the incoming sideband registers 145a, 145b.

Also in an exemplary embodiment, program code may be implemented by the bus agent to control the size of the micropackets. For example, the micropackets may include one or more sideband signal. In addition, the size of the micropackets may be changed over time (e.g., based on bus performance statistics and changing bus speeds and/or for different bus links), so as to maximize the number of sideband signals that can be issued over the bus 120 without interfering with conventional bus traffic.

Before continuing, it is noted that both the bus master 130 and the bus communicator 135 may ignore the sideband signals or micropackets being issued over the bus. For example, while the bus master 130 may detect that a signal is present on the bus 120, the bus master 130 does not take any action with regard to the signal because the sideband signals or micropackets are treated by the bus master 130 merely as a “no request,” ACK/NACK, or other similar signal, which the bus master 130 and bus communicator 135 would typically ignore.

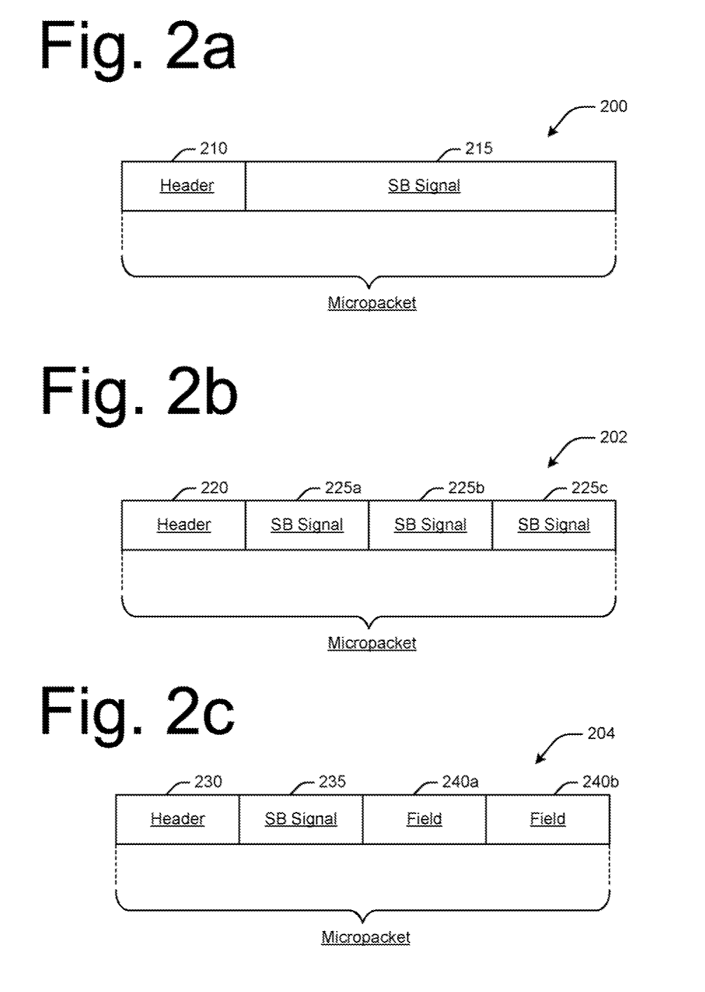

FIGS. 2a-c are high level illustrations of exemplary micropackets. FIG. 2a shows a micropacket 200 including a header 210, and one sideband signal 215. Header 210 may include information about the corresponding micropacket 215. For example, header data may include, but is not limited to, the packet destination and packet length.

By way of example where the bus agent utilizes TDM to issue the micropackets onto the bus, the header may include extra bits for error control and/or sequencing control (to indicate the position of a particular micropacket in a sequence of micropackets) and/or to indicate priority level for a particular micropacket.

FIG. 2b illustrates another exemplary micropacket 202 also including header 220 and a plurality of sideband signals 225a-c. Although four sideband signals are shown as they may be packaged into a single micropacket 202, it is understood that more or less sideband signals may be packaged into a single micropacket 202.

FIG. 2c illustrates another exemplary micropacket 204 also including header 230 and at least one sideband signal 235. In addition, micropacket 204 also includes at least one other field (fields 240a and 240b are shown). One or more other fields may be used for other signal processing data (e.g., a cross-reference to another micropacket containing related sideband signals).

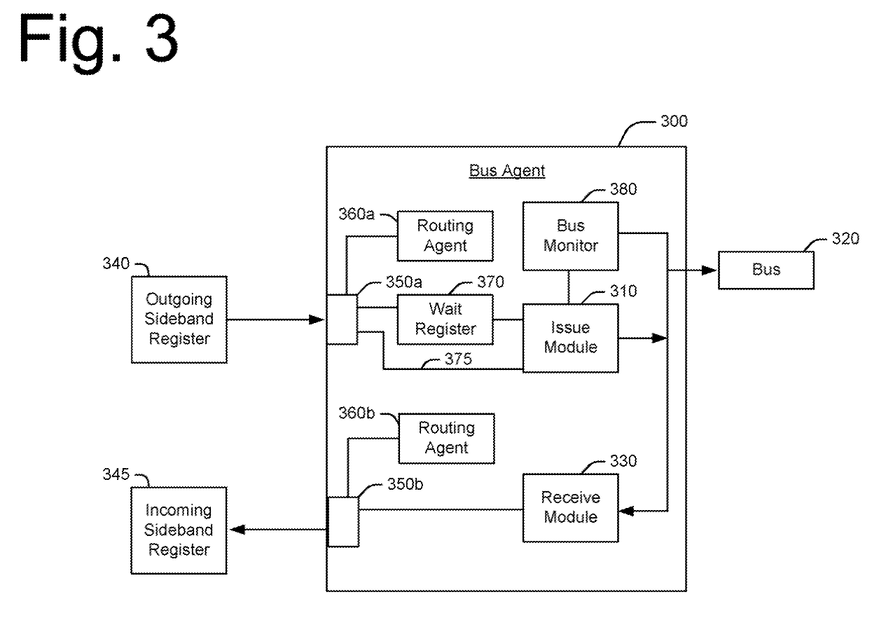

FIG. 3 is a detailed schematic diagram of an exemplary bus agent 300 (e.g., the bus agents 150a and 150b shown in FIG. 1) as it may be implemented in a multichip system (e.g., the multichip system 100 shown in FIG. 1) for bus arbitration for sideband signals. Bus agent 300 may be implemented as program code (e.g., firmware) including logic instructions executable for bus arbitration for sideband signals in a multichip system. The logic instructions may be encoded as functional modules.

Bus agent 300 may include issue module 310 operatively associated with a bus 320 for outgoing transactions. Bus agent 300 may also include a receive module 330 operatively associated with the bus 320 for incoming transactions. The issue module 310 may also be operatively associated with an outgoing sideband register 340; and the receive module 330 may be operatively associated with an incoming sideband register 345.

In an exemplary embodiment, bus agent 300 may include a synchronizer 350a for operatively associating the issue module 310 with the outgoing sideband register 340; and a synchronizer 350b for operatively associating the receive module 330 with the incoming sideband register 345.

Routing agents 360a, 360b function with synchronizers 350a, 350b, respectively, to handle the micropackets. Routing agents 360a, 360b may be implemented as program code (e.g., firmware) and may include logic instructions for managing traffic flow. For example, the routing agents 360a, 360b may load micropackets into the respective registers and the issuing module 310 or receive module 330.

Bus agent 300 may also include a wait register 370. In some circumstances, the micropackets may include more micropackets than can be issued on the bus 320. Accordingly, the micropacket is held in the wait register 370 until the issue module is ready for another micropacket. A bypass 375 may be provided when the wait register 370 is not needed.

Bus monitor 380 may be operatively associated with the bus 320 to determine when the bus 320 is in a quiescent state. Bus monitor may be implemented as a state machine to detect whether usual bus traffic is being handled on the bus 320. Bus monitor may also be operatively associated with the issue module 310. When the bus monitor detects that the bus 320 is in a quiescent state, issue module 310 may issue sideband signals or micropackets onto the bus 320.

Issue module 310 may also include program code to package sideband signals from the outgoing sideband register 340 as micropackets before issuing on the bus 320. Still other program code may be executed by the issue module 310 to process the micropackets. For example, the issue module 310 may include program code for sequencing sideband signals. In exemplary embodiments where TDM is utilized, the issue module 310 may implement a multiplexer. Also in an exemplary embodiment, the issue module 310 may execute program code for adding the header, error control bits, etc.

Receive module 330 may also include program code to unpackage sideband signals from the micropackets received from the bus 320 and write the sideband signals to the incoming sideband register 345. Still other program code may be executed by the receive module 330 to process the micropackets. For example, the receive module 330 may include program code for sequencing sideband signals. In exemplary embodiments where TDM is utilized, the receive module 330 may implement a de-multiplexer.

Also in an exemplary embodiment, the receive module 330 may implement a valid detect module to evaluate micropackets (e.g., based on the header, error control bits, etc.). Only valid micropackets may be written to the incoming sideband register 345. Invalid micropackets may be rejected by the valid detect module.

It is noted that exemplary bus agent 300 is shown and described with reference to FIG. 3 as including a plurality of functional modules for purposes of illustration. Such an embodiment is not intended to be limiting. For example, the functions described herein do not need to be encapsulated as separate functional modules. In addition, other functional aspects may also be provided and are not limited to those shown and described herein.

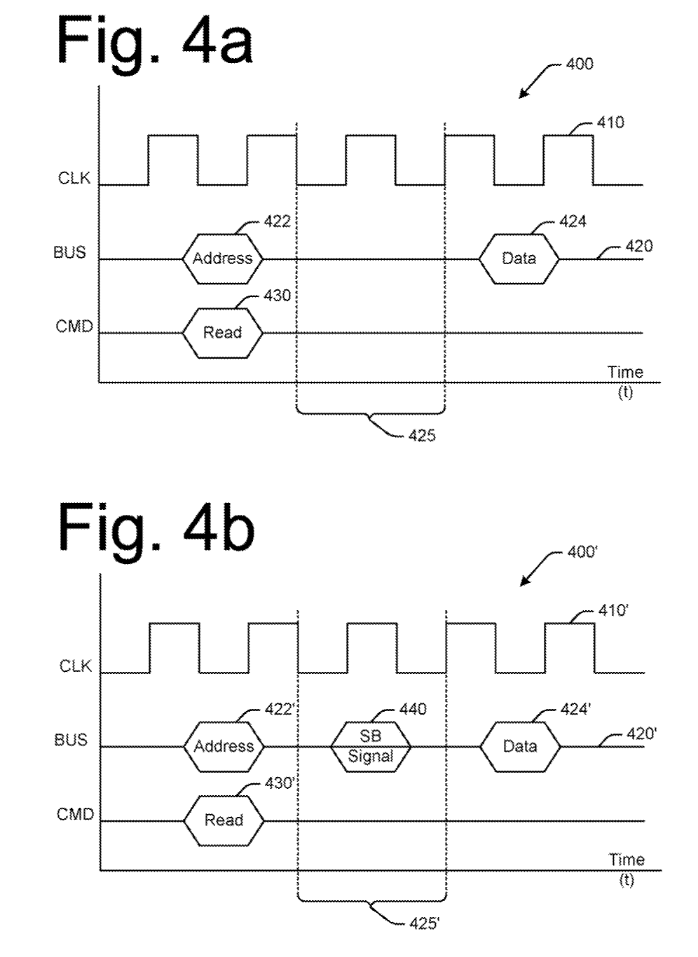

FIGS. 4a and 4b are timing diagrams 400 and 400′ illustrating exemplary bus arbitration for sideband signals. It is noted that prime designations are used to represent similar signals in FIG. 4b as represented in FIG. 4a, and therefore a description may not be repeated for FIG. 4b. As discussed above, bus arbitration for sideband signals may be implemented by the bus agent. For example, the bus agent may monitor the bus for a quiescent state, and then issue sideband signals as micropackets onto the bus during the quiescent state so as to not interfere with usual bus traffic.

The timing diagram 400 illustrates a clock signal 410. Under the clock signal 410 is illustrated a bus signal 420 for a read command 430 showing an address packet 422 being issued on the bus, followed by a data packet 424. Between the address packet 422 and the data packet 424 being issued on the bus are idle clock cycles, as illustrated by bracket 425.

During these idle cycles, the bus is in a quiescent state. The bus agent detects the quiescent state, and can then utilize the bus to issue the sideband signals (or micropackets) 440 on the bus without interfering with usual bus traffic, as showN by timing diagram 400′. Specifically, the bus master is idle, and waiting for a read return data. Since there is no CMD, the bus master state machine is un-affected. The sideband bus monitor sees a read in progress. It directs the issue module 310 to insert the sideband micropacket onto the bus without issuing a command. The receiving bus agent 150b also snoops the bus and sees a read transaction, thus extracting the data from the bus.

In an exemplary embodiment, the systems and methods described herein are well-suited to implementation by TDM. TDM is a technique which enables a plurality of low bit-rate streams (i.e., the sideband signals or micropackets) to be integrated into a single high-bit rate stream on a single channel (i.e., the bus). The high bit-rate stream is divided into a number of time slots which are alternately used by either usual bus traffic and the sideband signals or micropackets. All sources are thus capable of transmitting data on the bus without interfering with the usual bus traffic.

The bus agent at the issuing chip may therefore implement, or be operatively associated with, a multiplexer for issuing the sideband signals or micropackets onto the bus using TDM. Accordingly, the bus agent at the issuing chip is responsible for determining the size of the micropackets based on the available time slots. This determination involves a trade-off between efficiency and delay. If the time slots are too small, then the multiplexer must be fast enough to switching between usual bus traffic and issuing the sideband signals. If the time slots are too big, then the sideband registers must be large enough to store all of the sideband signals until these signals can be issued onto the bus. In addition, this will also introduce delay. Although sideband signals are generally such that the signals are latency-tolerant, this too will involve design trade-offs. It is noted that the bus agent at the receiving chip may also implement, or be operatively associated with, a de-multiplexer for demultiplexing the sideband signals or micropackets received from the bus using TDM.

It is noted that the exemplary systems discussed above are provided for purposes of illustration. Still other implementations and embodiments are also contemplated. For example, bus arbitration for sideband signals in a multichip system is not limited to use with TDM. Other signal processing techniques may also be utilized.

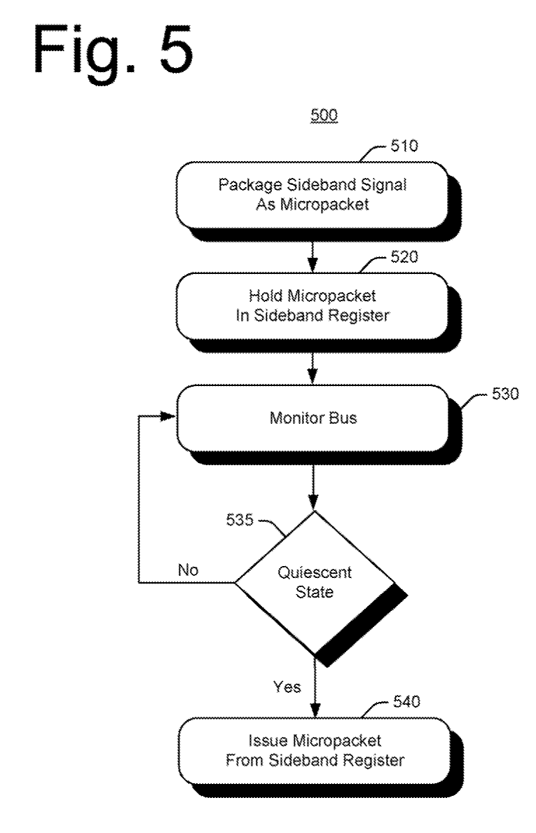

FIG. 5 is a flowchart illustrating exemplary operations of bus arbitration for sideband signals in a multichip system. Operations 500 may be embodied as logic instructions on one or more computer-readable medium. When executed the logic instructions cause processing units or processors to be programmed for implementing the described operations. In an exemplary embodiment, the components and connections depicted in the figures may be used for bus arbitration for sideband signals in a multichip system.

In operation 510, at least one sideband signal may be packaged as a micropacket. Of course in other embodiments, the sideband signal need to be packaged as a micropacket, e.g., where the sideband signal is to be issued on the bus “as-is.” In operation 520, the micropacket may be held in an outgoing sideband register. In operation 530, a bus may be monitored for a quiescent state. For example, the bus agent may monitor the bus. If the bus is not in a quiescent state in operation 535, then the bus agent continues to monitor the bus in operation 530. If the bus has entered a quiescent state in operation 535, then in operation 540, the micropacket may be issued on the bus from the outgoing sideband register.

The operations shown and described herein are provided to illustrate exemplary embodiments of bus arbitration for sideband signals in a multichip system. It is noted that the operations are not limited to the ordering shown and described. In addition, still other operations may also be implemented, in addition to, or alternatively to one or more of the operations discussed above. For example, multiplexing/de-multiplexing operations may be implemented for TDM. Similarly, operations may also be implemented to receive and process the micropacket at another chip.

By way of further example, still other operations may comprise determining which of a plurality of micropackets in the outgoing sideband register are output from the outgoing sideband register if the bus is in a quiescent state. Operations may also comprise receiving micropackets from the bus at an incoming sideband register. Still other operations may comprise ignoring the micropackets as conventional bus transactions.

In addition to the specific embodiments explicitly set forth herein, other aspects and embodiments will be apparent to those skilled in the art from consideration of the specification disclosed herein. It is intended that the specification and illustrated embodiments be considered as examples only.

1. A method of bus arbitration for sideband signals in a multichip system comprising:
packaging at least one sideband signal as a micropacket;
holding the micropacket in an outgoing sideband register;
monitoring a bus for a quiescent state, the bus having a plurality of links to other chips in the multichip system; and
issuing the micropacket from the outgoing sideband register when the bus is in a quiescent state.

2. The method of claim 1 further comprising determining which of a plurality of micropackets in the outgoing sideband register are output from the outgoing sideband register when the bus is in a quiescent state.

3. The method of claim 1 further comprising receiving micropackets from the bus at an incoming sideband register.

4. The method of claim 1 further comprising a bus master of the bus ignoring the micropackets as usual bus transactions.

5. The method of claim 1 wherein the sideband signals are not issued to other chips in the multichip system via dedicated connections.

6. A system of bus arbitration for sideband signals in a multichip system, comprising:
an outgoing sideband register for storing sideband signals as micropackets; and
a bus agent operatively associated with a bus, the bus having a plurality of links to other chips in the multichip system, the bus agent monitoring if the bus is in a quiescent state, wherein at least one of the micropackets is issued from the outgoing sideband register when the bus is in a quiescent state.

7. The system of claim 6 wherein the bus agent further comprises an arbitrator operatively associated with the outgoing sideband register and the bus agent, the arbitrator determining which micropackets are output from the outgoing sideband register when the bus agent detects the bus is in a quiescent state.

8. The system of claim 6 wherein the bus agent includes a state machine operatively associated with the bus to determine a state of the bus.

9. The system of claim 6 wherein the micropackets are invalid signals to a bus master of the bus.

10. The system of claim 6 wherein a bus master for the bus ignores the micropackets.

11. The system of claim 6 wherein micropackets received from the bus are placed in an incoming sideband register.

12. The system of claim 6 wherein the micropackets include only latency-tolerant sideband signals.

13. The system of claim 6 wherein the sideband register is encoded for a maximum expected number of micropackets.

14. A system of bus arbitration for sideband signals, comprising:
at least a first chip and a second chip in a multichip system;
a bus linking at least the first chip and the second chip in the multichip system;
an outgoing sideband register on at least the first chip and the second chip in the multichip system, the outgoing sideband register configured to store sideband signals; and
a bus agent on at least the first chip and the second chip in the multichip system, the bus agent operatively associated with the bus, the bus agent detecting when the bus is in a quiescent state, wherein the sideband signals in the outgoing sideband register are issued from the outgoing sideband register when the bus is in a quiescent state.

15. The system of claim 14 wherein the bus agent further comprises an arbitrator, the arbitrator determining which sideband signals are output to the bus from the outgoing sideband register.

16. The system of claim 14 wherein sideband signals received from the bus are issued to an incoming sideband register.

17. The system of claim 14 wherein the sideband signals are latency-tolerant.

18. The system of claim 14 wherein the bus agent further comprises a transaction packager, the transaction packager converting the sideband signals to micropackets.

19. The system of claim 14 wherein the bus agent further comprises a transaction packager, the transaction packager converting micropackets received from the bus into sideband signals.

20. The system of claim 14 wherein the bus agent is operatively associated with a multiplexer/demultiplexer for issuing/receiving the micropackets over the bus using time division multiplexing (TDM).
